(19) United States
(12) Patent Application Publication
(10) Pub. No.: US 2006/0179098 A1
(43) Pub. Date: Aug. 10, 2006

(54) System and method for reduction of leading zero detect for decimal floating point numbers

(75) Inventors: Michael R. Kelly, Wappingers Falls, NY (US); Wen H. Li, Poughkeepsie, NY (US); Eric M. Schwarz, Gardiner, NY (US); Wai Y. Wong, Brewster, NY (US)

Correspondence Address: CANTOR COLBURN LLP-IBM POUGHKEEPSIE, 55 GRIFFIN ROAD SOUTH, BLOOMFIELD, CT, 06002, US

(73) Assignee: International Business Machines Corporation, Armonk, NY (US)

(21) Appl. No.: 11/054,234

(22) Filed: Feb. 9, 2005

(51) Int. Cl. G06F 7/38

(52) U.S. Cl. 708/495

(57) ABSTRACT

A method for leading zero detection. The method includes receiving DPD encoded data representing a three digit BCD number and determining directly from the DPD encoded data if the BCD number represented by the DPD encoded data contains at least one leading zero digit. A group one switch is set to zero if it was determined that the BCD number represented by the DPD encoded data contains at least one leading zero digit and set to one otherwise. The method also includes determining directly from the DPD encoded data if the BCD number represented by the DPD encoded data contains at least two leading zero digits. A group two switch is set to zero if it was determined that the BCD number represented by the DPD encoded data contains at least two leading zero digits and set to one otherwise. The method further includes determining directly from the DPD encoded data if the BCD number represented by the DPD encoded data contains three leading zero digits. A group three switch is set to zero if was determined that the BCD number represented by the DPD encoded data contains three leading zero digits and set to one otherwise.

### TRADEMARKS

IBM® is a registered trademark of International Business Machines Corporation, Armonk, N.Y., U.S.A. S/390, Z900 and z990 and other names used herein may be registered trademarks, trademarks or product names of International Business Machines Corporation or other companies.

### BACKGROUND OF THE INVENTION

This invention relates generally to leading zero detection, and more particularly, to the reduction of leading zero detect for decimal floating point numbers.

Decimal floating point numbers have a sign bit, a combination field, an exponent continuation field, and a coefficient continuation field. The coefficient continuation field may be compressed using a densely packed decimal (DPD) encoding format where three decimal digits that normally take up twelve bits (e.g., three sets of four bit binary coded decimal (BCD) encodings) are compacted into ten bits. Each ten bit DPD compressed field is called a declet. DPD encoding provides a much greater compression than BCD (1000 values/1024 encodings versus 10 values/16 encodings for BCD). If fewer than three decimal digits are received, the digits can be padded with zeros to provide a consistent input size of three digits (or twelve bits if BCD input is used). DPD encoding is described, for example, in U.S. Pat. No. 6,437,715 to Cowlishaw, of common assignment herewith.

Decimal data may be compressed into DPD format to take up less storage space. In general, decimal data is unnormalized and some arithmetic algorithms need to be adjusted based on how many leading zeros are in the operand. For instance, if the input operand is small, such as subnormal, underflow could occur. Or if the operation is an add operation and there are leading zeros and the exponents are equal, then the operation will have no shifting or rounding. As shown by the previous examples, it may be critical to the performance of the system to perform early leading zero detection. Currently, leading zero detection is performed after the DPD data is converted back into BCD data. It would be desirable to be able to perform leading zero detection on compressed data that is in the DPD format in order to perform leading zero detection earlier and therefore improve system performance.

### BRIEF SUMMARY OF THE INVENTION

Exemplary embodiments of the present invention include a method for leading zero detection. The method includes receiving DPD encoded data representing a three digit BCD number and determining directly from the DPD encoded data if the BCD number represented by the DPD encoded data contains at least one leading zero digit. A group one switch is set to zero if it was determined that the BCD number represented by the DPD encoded data contains at least one leading zero digit and set to one otherwise. The method also includes determining directly from the DPD encoded data if the BCD number represented by the DPD encoded data contains at least two leading zero digits. A group two switch is set to zero if it was determined that the BCD number represented by the DPD encoded data contains at least two leading zero digits and set to one otherwise. The method further includes determining directly from the DPD encoded data if the BCD number represented by the DPD encoded data contains three leading zero digits. A group three switch is set to zero if was determined that the BCD number represented by the DPD encoded data contains three leading zero digits and set to one otherwise.

Additional exemplary embodiments include a system for leading zero detection. The system includes an input latch for storing DPD encoded data representing a three digit BCD number, a group one switch, a group two switch, a group three switch, and a mechanism. The mechanism facilitates receiving the DPD encoded data into the input latch. It is determined directly from the DPD encoded data if the BCD number represented by the DPD encoded data contains at least one leading zero digit. A group one switch is set to zero if it was determined that the BCD number represented by the DPD encoded data contains at least one leading zero digit and set to one otherwise. It is determined directly from the DPD encoded data if the BCD number represented by the DPD encoded data contains at least two leading zero digits. A group two switch is set to zero if it was determined that the BCD number represented by the DPD encoded data contains at least two leading zero digits and set to one otherwise. It is determined directly from the DPD encoded data if the BCD number represented by the DPD encoded data contains three leading zero digits. A group three switch is set to zero if it was determined that the BCD number represented by the DPD encoded data contains three leading zero digits and set to one otherwise.

Further exemplary embodiments include a system for leading zero detection. The system includes an input latch for storing DPD encoded data, where the DPD encoded data includes one or more sets of ten bits, each representing three digits of a BCD number. The system also includes a mechanism for facilitating receiving the DPD encoded data into the input latch. The following loop is performed for each set of ten bits of DPD encoded data: determining directly from the DPD encoded data if the BCD digits represented by the DPD encoded data contain at least one leading zero digit; setting a group one switch to zero if it was determined that the BCD digits represented by the DPD encoded data contain at least one leading zero digit and set to one otherwise; determining directly from the DPD encoded data if the BCD digits represented by the DPD encoded data contain at least two leading zero digits; setting a group two switch to zero if it was determined that the BCD digits represented by the DPD encoded data contain at least two leading zero digits and to one otherwise; determining directly from the DPD encoded data if the BCD digits represented by the DPD encoded data contain three leading zero digits; setting a group three switch to zero if was determined that the BCD digits represented by the DPD encoded data contain three leading zero digits and to one otherwise; and outputting the group one switch, the group two switch and the group three switch to a leading zero detector.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a block diagram of leading zero detection process for densely packed decimals (DPDs) where DPD declets are converted into binary coded decimal (BCD) format before performing the leading zero detection;

FIG. 2 is an exemplary table of the mapping between three BCD digits and a ten bit DPD declet that may be utilized by exemplary embodiments of the present invention;

FIG. 3 is a block diagram of an exemplary embodiment of a leading zero detection process for DPD declets where the declet is not converted into a BCD format before performing the leading zero detection; and

FIG. 4 is a block diagram of a DPD declet not-zero detector that may be utilized by exemplary embodiments of the present invention.

The detailed description explains the preferred embodiments of the invention, together with advantages and features, by way of example with reference to the drawings.

### DETAILED DESCRIPTION OF THE PREFERRED EMBODIMENTS

Exemplary embodiments of the present invention perform a zero detect directly from data in a densely packed decimal (DPD) format, rather than expanding the data to a binary coded decimal (BCD) format and then performing a zero detect. This allows the zero detect to be performed earlier. In exemplary embodiments of the present invention, the leading zero detect is performed directly on the compressed DPD data. Three signals are produced from each ten bit declet in the DPD formatted data: Z3 to indicate if all three digits are zero; Z2 to indicate if the left two digits are zero; and Z1 to indicate if the left digit is zero. Then, the rest of the zero detect tree is reduced based on groups of three digits.

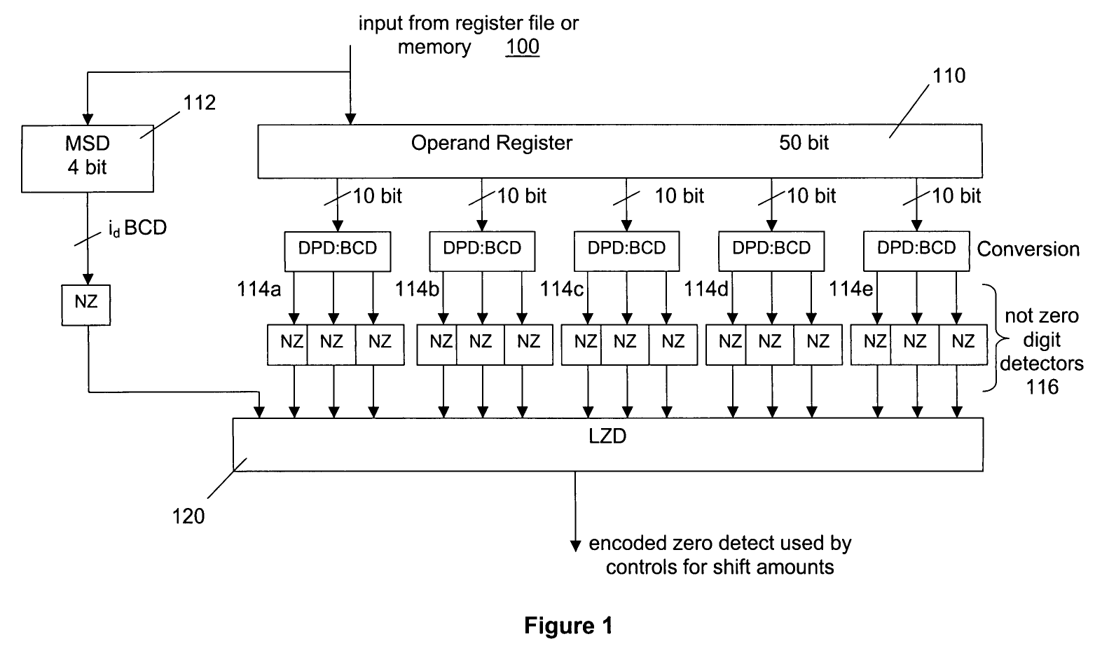

FIG. 1 is a block diagram of a typical leading zero detection process for DPD format, where the declets are converted into a BCD format before performing the leading zero detection. Input data 100 from a register file or memory is in the DPD format (i.e. three decimal digits represented in ten bits) with the exception of the most significant digit 112 which is in BCD format. The input data 100 that is in the DPD format is entered into a fifty-bit operand register 110. As depicted in FIG. 1, each ten bit DPD declet is entered into a DPD to BCD converter 114 to perform a conversion from DPD to BCD. The three BCD digits are output from each DPD to BCD converters 114 into not-zero digit detectors 116. In addition, the most significant digit 112 of the BCD number is input to the not-zero digit detector 116. The output of the not-zero digit detectors 116 is zero if the BCD digit is zero and one otherwise. The not-zero digit detector 116, as known in the art, may be implemented by an OR gate that has as input the four bits of the BCD digit and produces an output of zero if all four bits in the BCD digits are equal to zero. The result of the not-zero digit detector 116 for each BCD digit is input to a leading zero detect block 120. Output from the leading zero detect block 120 is an encoded zero detect (specifying the number of leading zeros) that may be utilized by controls in the system for determining shift amounts. The process depicted in FIG. 1 requires a conversion from DPD to BCD in order to perform the zero detection.

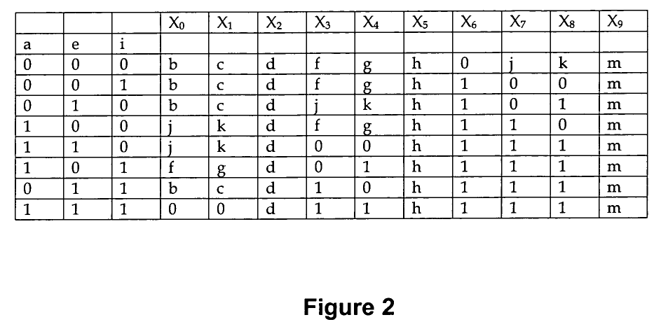

FIG. 2 depicts an example BCD to DPD conversion table that is utilized by exemplary embodiments of the present invention. The letters a-k and m represent the twelve bits of three BCD digits, where the three BCD digits include “abcd” “efgh” and “ijkm.” The symbols X0-X9 represent the ten bits of the DPD encoded digits. A primary indicator field is utilized to indicate whether or not the three digits are all small, where a decimal digit is regarded as small if it is in the range 0-7, and large if it is 8 or 9. In FIG. 2, the primary indicator field is the column labeled X6.

If the three decimal digits are not all small, then a secondary indicator field of two bits is included in the ten binary bits. This field has a first value to indicate that more than one of the decimal digits is large, and second, third and fourth values to indicate which of the three decimal digits is large, if just one of the decimal digits is large. In FIG. 2, the columns labeled X7 and X8 contain the secondary indicator field (again outside the set of bit positions which have to go to zero if only one or two decimal digits are being encoded). If two or more of the decimal digits are large, a tertiary indicator field of two further bits is provided in the ten output bits. This field has a first value to indicate that all three of the decimal digits are large, and second, third and fourth values to indicate which of the decimal digits is small, if just one of the decimal digits is small. In FIG. 2, the columns labeled X3 and X4 contain the tertiary indicator.

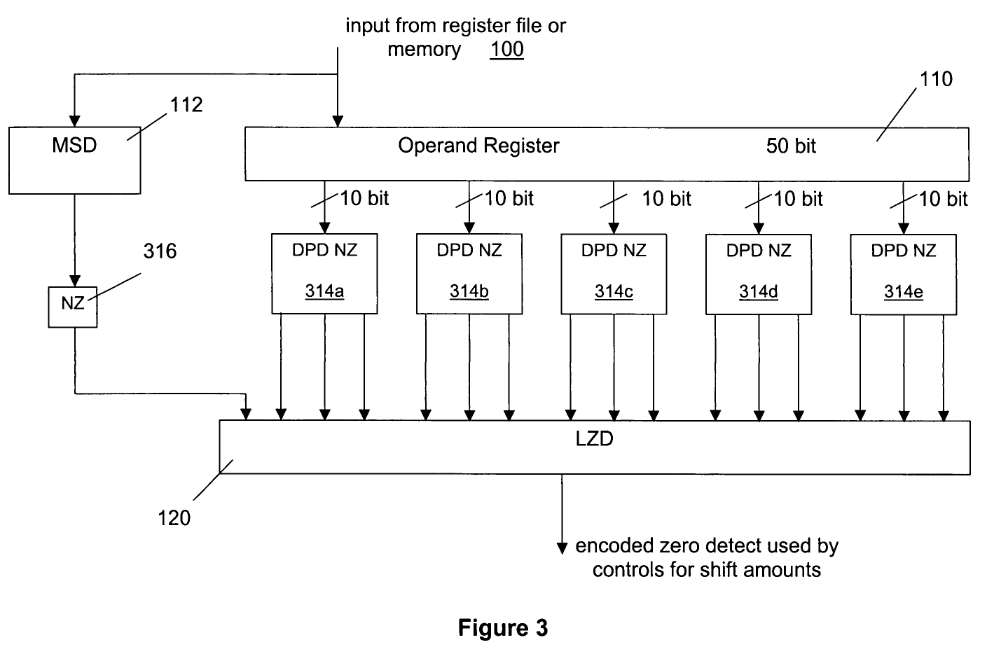

FIG. 3 is a block diagram of an exemplary embodiment of the present invention for providing a leading zero detection process, where DPD formatted data is not converted into a BCD format before performing the leading zero detection. Input data 100 from a register file or memory is in the DPD format (i.e. three decimal digits represented in ten bits as described in reference to FIG. 2) with the exception of the most significant digit 112 which is in the BCD format. In the exemplary embodiment depicted in FIG. 3, the input data 100 that is in the DPD format (e.g., five DPD digits including ten bits each) is entered into a fifty bit or five declet operand register 110. In addition, the most significant digit 112 of the BCD number is input to a not-zero digit detector 316. Other configurations may be implemented by exemplary embodiments of the present invention. For example, operand registers 110 of other sizes may be utilized by exemplary embodiments of the present invention to accommodate other number of DPD declets and/or the most significant digit 112 may also be in the DPD format and input to the operand register 110.

Each ten bit DPD declet (representing up to three digits of a BCD number) from the operand register 110 is input to a DPD not-zero detector 314. The DPD not-zero detectors 314 determine if the first BCD digit is zero, if the first and second BCD digits are zero and if all three of the BCD digits are zero. The result of the DPD not-zero detectors 314 for each ten bit DPD declet is input to the leading zero detect block 120 (also referred to herein as a leading zero detector) along with the output from the not-zero digit detector 316. Output from the leading zero detect block 120 is an encoded zero detect (specifying the number of leading zeros) that may be utilized by controls in the system for determining shift amounts. The process depicted in FIG. 3 does not require a conversion from DPD to BCD in order to perform the zero detection and therefore may lead to improved system performance due to earlier detection of leading zeros.

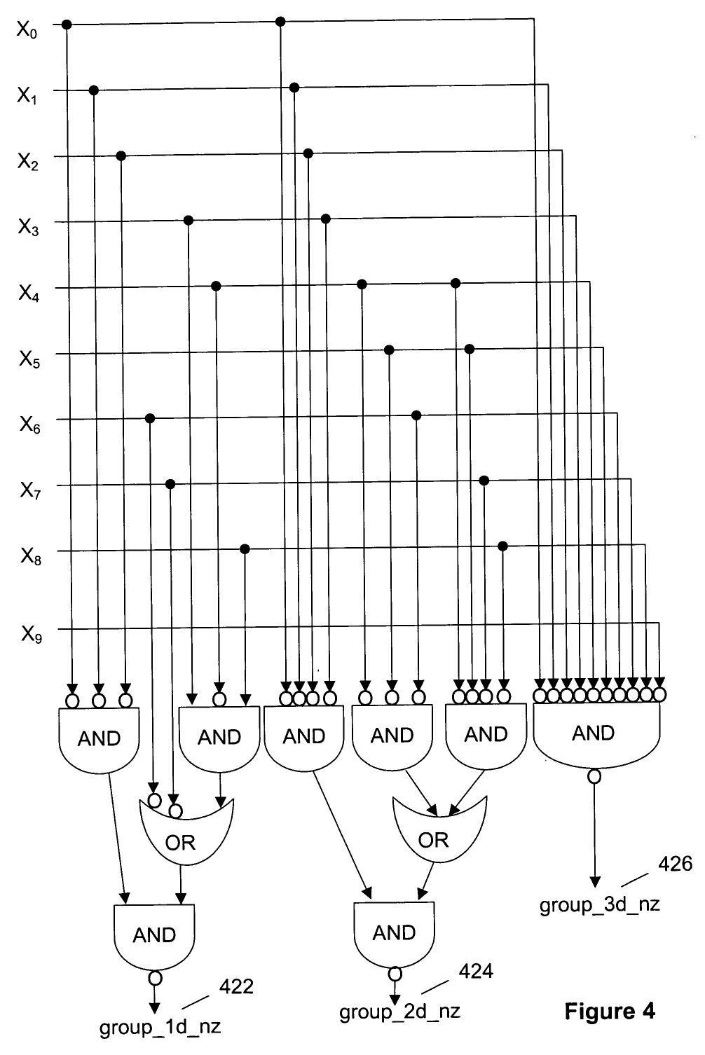

FIG. 4 is a block diagram of a DPD not-zero detector 314 that may be utilized by exemplary embodiments of the present invention. Input to the DPD not-zero detector 314 includes a ten bit DPD declet. Output from the DPD not-zero detector 314 includes a group_{—}1d_nz indicator 422 (also referred to herein as a group one switch) that is set to zero if the first BCD digit is equal to zero (where the ten bit DPD declet represents three BCD digits) and set to one otherwise. Output from the DPD not-zero detector 314 includes a group_{—}2d_nz indicator 424 (also referred to herein as a group two switch) that is set to zero if the first two BCD digits are equal to zero and set to one otherwise. Output from the DPD not-zero detector 314 includes a group_{—}3d_nz indicator 426 (also referred to herein as a group three switch) that is set to zero if all three of the BCD digits are equal to zero and set to one otherwise. The output from the DPD not-zero detector 314 is input to the leading zero detector 120.

As depicted in FIG. 4, group_{—}1d_nz indicator 422 may be calculated by the following formula: group_{—}1d_nz [symbol] {overscore ((x₀\overline{x}₁\overline{x}₂)(\overline{x}₆+\overline{x}₇+(x₃\overline{x}₄x₈). Note that an overbar represents inversion, +represents the logical OR operation, and juxtaposition represents the logical AND operation, and were the result is equal to zero if the first BCD digit is equal to zero. The group_{—}2d_nz indicator 424 may be calculated by the following formula: group_{—}2d_nz [symbol] {overscore ((\overline{x}₀\overline{x}₁\overline{x}₂\overline{x}₃)((\overline{x}₄\overline{x}₅\overline{x}₆)+(\overline{x}₄\overline{x}₅\overline{x}₇\overline{x}₈)), where the result is equal to zero if the first two BCD digits are equal to zero. The group_{—}3d_nz indicator 426 may be calculated by the following formula: group_{—}3d_nz [symbol] {overscore (\overline{x}₀\overline{x}₁\overline{x}₂\overline{x}₃\overline{x}₄\overline{x}₅\overline{x}₆\overline{x}₇\overline{x}₈\overline{x}₉, the result is equal to zero if all three of the BCD digits are equal to zero.

By forming the leading zero detect off the encoded DPD format, this information is available much earlier. By this method, the number of leading zeros may be known at the same time the coefficient is available in a BCD format. This allows much faster processing of floating point operations, such as floating point addition which must calculate the number of digits that an operand can be shifted left prior to exceeding the width of the hardware adder which would then require a subsequent shift right of the smaller operand.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention, can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another.

1. A method for leading zero detection, the method comprising:
receiving DPD encoded data representing a three digit BCD number;
determining directly from the DPD encoded data if the BCD number represented by the DPD encoded data contains at least one leading zero digit;
setting a group one switch to zero if it was determined that the BCD number represented by the DPD encoded data contains at least one leading zero digit and to one otherwise;
determining directly from the DPD encoded data if the BCD number represented by the DPD encoded data contains at least two leading zero digits;
setting a group two switch to zero if it was determined that the BCD number represented by the DPD encoded data contains at least two leading zero digits and to one otherwise;
determining directly from the DPD encoded data if the BCD number represented by the DPD encoded data contains three leading zero digits; and
setting a group three switch to zero if was determined that the BCD number represented by the DPD encoded data contains three leading zero digits and to one otherwise.

2. The method of claim 1 wherein DPD encoded data is received from memory.

3. The method of claim 1 wherein the DPD encoded data is received from a register file.

4. The method of claim 1 wherein the group one switch, the group two switch and the group three switch are input to a leading zero detector.

5. The method of claim 1 wherein the DPD encoded data includes ten bits.

6. A system for leading zero detection, the system comprising:
an input latch for storing DPD encoded data representing a three digit BCD number;
a group one switch;
a group two switch;
a group three switch; and
a mechanism for:
receiving the DPD encoded data into the input latch;
determining directly from the DPD encoded data if the BCD number represented by the DPD encoded data contains at least one leading zero digit;
setting the group one switch to zero if it was determined that the BCD number represented by the DPD encoded data contains at least one leading zero digit and to one otherwise;
determining directly from the DPD encoded data if the BCD number represented by the DPD encoded data contains at least two leading zero digits;
setting the group two switch to zero if it was determined that the BCD number represented by the DPD encoded data contains at least two leading zero digits and to one otherwise;
determining directly from the DPD encoded data if the BCD number represented by the DPD encoded data contains three leading zero digits; and
setting the group three switch to zero if was determined that the BCD number represented by the DPD encoded data contains three leading zero digits and to one otherwise.

7. The system of claim 6 wherein DPD encoded data is received from memory.

8. The system of claim 6 wherein the DPD encoded data is received from a register file.

9. The system of claim 6 wherein the group one switch, the group two switch and the group three switch are input to a leading zero detector.

10. The system of claim 6 wherein the DPD encoded data includes ten bits.

11. A system for leading zero detection, the system comprising:
an input latch for storing DPD encoded data, wherein the DPD encoded data includes one or more sets of ten bits each representing three digits of a BCD number; and
a mechanism for:
receiving the DPD encoded data into the input latch;
performing for each set of ten bits of DPD encoded data:
determining directly from the DPD encoded data if the BCD digits represented by the DPD encoded data contain at least one leading zero digit;
setting a group one switch to zero if it was determined that the BCD digits represented by the DPD encoded data contain at least one leading zero digit and to one otherwise;
determining directly from the DPD encoded data if the BCD digits represented by the DPD encoded data contain at least two leading zero digits;
setting a group two switch to zero if it was determined that the BCD digits represented by the DPD encoded data contain at least two leading zero digits and to one otherwise;
determining directly from the DPD encoded data if the BCD digits represented by the DPD encoded data contain three leading zero digits;
setting a group three switch to zero if was determined that the BCD digits represented by the DPD encoded data contain three leading zero digits and to one otherwise; and
outputting the group one switch, the group two switch and the group three switch to a leading zero detector.

12. The system of claim 11 further comprising:
a most significant digit register for storing in BCD format a most significant digit of the BCD number represented by the DPD encoded data; and
a not-zero block for determining if the most significant digit is equal to zero, wherein the mechanism further: receives the most significant digit into the most significant digit register, inputs the most significant digit into the not-zero block to determine if the most significant digit is equal to zero, and outputs a zero to a leading zero detector if it was determined that the most significant digit was equal to zero and to one otherwise.
